(19) United States
(12) Patent Application Publication
(10) Pub. No.: US 2017/0155998 A1
(43) Pub. Date: Jun. 1, 2017

(54) Vehicle with display system for interacting with wearable device

(71) Applicant: BRAGI GmbH, Munchen (DE)

(72) Inventor: Peter Vincent Boesen, Munchen (DE)

(21) Appl. No.: 15/357,096

(22) Filed: Nov. 21, 2016

Related U.S. Application Data
(60) Provisional application No. 62/260,446, filed on Nov. 27, 2015.

(51) Int. Cl. H04R 1/10; G06F 17/30; G06F 3/041

(52) U.S. Cl. CPC H04R 1/1041; G06F 3/0416; G06F 17/30053; H04R 2420/07

(57) ABSTRACT

A system includes a vehicle, a vehicle network disposed within the vehicle, and a vehicle display operative connected to the vehicle network. The vehicle network is configured to wirelessly communicate with at least one wireless earpiece to receive data from the at least one wireless earpiece and display information associated with the at least one wireless earpiece on the vehicle display. The vehicle may also be configured to receive input from an occupant wearing the at least one wireless earpiece using the vehicle display and communicate the input to the at least one wireless earpiece.

### PRIORITY STATEMENT

This application claims priority to U.S. Provisional Patent Application 62/260,446, filed on Nov. 27, 2015, and entitled Vehicle with display system for interacting with wearable device, hereby incorporated by reference in its entirety.

### FIELD OF THE INVENTION

The present invention relates to wearable devices and vehicles. More particularly, but not exclusively, the present invention relates to the interaction between one or more wearable earpieces and a vehicle's entertainment system.

### BACKGROUND

Vehicles may come with various types of electronics packages. These packages may be standard or optional and include electronics associated with communications, navigation, or entertainment. However, there are various problems and deficiencies with such offerings. What is needed are vehicles with improved electronics options which create, improve, or enhance overall experience of vehicles. In particular, what is needed are vehicles which integrate with wearable devices.

### SUMMARY

Therefore, it is a primary object, feature, or advantage of the present invention to improve over the state of the art.

It is another object, feature, or advantage of the present invention to communicate between vehicle systems and wearable devices.

It is a further object, feature, or advantage of the present invention to use wearable devices within vehicles and to provide enhanced vehicle functionality.

It is another object, feature, or advantage of the present invention to collect information from a vehicle and to communicate to a wearable device such as an earpiece.

It is yet another object, feature, or advantage to allow for a vehicle display to be used to display data from an earpiece or other wearable device.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

A system includes a vehicle, a vehicle network disposed within the vehicle, and a vehicle display operative connected to the vehicle network. The vehicle network is configured to wirelessly communicate with at least one wireless earpiece to receive data from the at least one wireless earpiece and display information associated with the at least one wireless earpiece on the vehicle display. The vehicle may be further configured to access audio files from the at least one wireless earpiece and display information about the audio files on the vehicle display. The vehicle may be further configured to access a playlist from the at least one wireless earpiece and display the playlist on the vehicle display. The vehicle may be further configured to access health monitoring data from the at least one wireless earpiece and display information about the health monitoring data on the vehicle display. The vehicle may be further configured to access a destination from the at least one wireless earpiece and display the destination on the vehicle display. The vehicle display may be a touchscreen display and the vehicle may be further configured to receive input from an occupant wearing the at least one wireless earpiece using the touch screen display and communicate the input to the at least one wireless earpiece.

According to another aspect, a method for communicating information to a wireless earpiece of an occupant within a vehicle is provided. The method includes providing a vehicle having a vehicle display in operative communication with a vehicle network of the vehicle, wirelessly connecting the vehicle to the wireless earpiece of the occupant within the vehicle, and receiving data from the wireless earpiece and displaying the data on the vehicle display of the vehicle. The data may be one or more audio files stored on the wireless earpiece or a playlist stored on the wireless earpiece or health monitoring data or a destination location stored on the wireless earpiece. The vehicle display may be a touchscreen display and the method may further include receiving input from the occupant of the vehicle at the touchscreen display and sending the input to the wireless earpiece.

### BRIEF DESCRIPTION OF THE DRAWINGS

FIG. 1 illustrates one example of use of a wearable device in conjunction with a vehicle.

FIG. 2 illustrates a wearable device in the form of a set of ear pieces.

FIG. 3 is a block diagram illustrating a device.

FIG. 4 illustrates a system which includes ear pieces in communication with a vehicle.

FIG. 5 illustrates a wearable device in communication with an entertainment system, navigation system and other systems having displays.

### DETAILED DESCRIPTION

Some of the most important factors in selecting a vehicle such as car may be the technology available to enhance the experience. This may be of particular importance in certain vehicle segments such as for luxury vehicles. Another important factor in selecting a vehicle may be the available safety features. According to various aspects, the present invention allows for wearable devices including ear pieces to enhance the experience of vehicles and according to some aspects, the present invention allows for wearable devices such as earpieces to enhance the overall safety of the vehicle. Therefore, it is expected that the technology described herein will make any vehicle so equipped more desirable to customers, more satisfying to customers, and potentially more profitable for the vehicle manufacturer. Similarly at least some of the various aspects may be added to existing vehicles as after-market accessories to improve the safety or experience of existing vehicles.

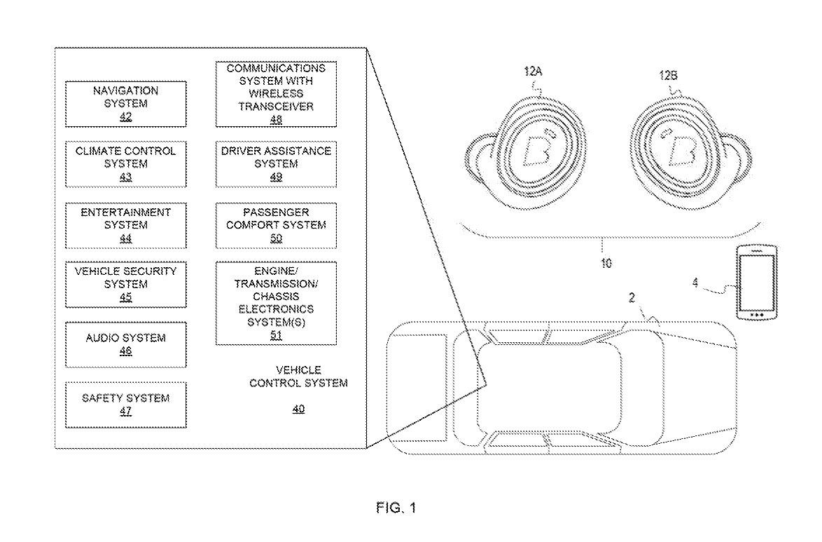

FIG. 1 illustrates one example of use of a wearable device in conjunction with a vehicle. A shown in FIG. 1 there is a vehicle 2. Although the vehicle shown is a full-size sedan, it is contemplated that the vehicle may be of any number of types of cars, trucks, sport utility vehicles, vans, mini-vans, automotive vehicles, commercial vehicles, agricultural vehicles, construction vehicles, specialty vehicles, recreational vehicles, buses, motorcycles, aircraft, boats, ships, yachts, spacecraft, or other types of vehicles. The vehicle may be gas-powered, diesel powered, electric, solar-powered, or human-powered. The vehicle may be actively operated by a driver or may be partially or completely autonomous or self-driving. The vehicle 2 may have a vehicle control system 40. The vehicle control system is a system which may include any number of mechanical, electrical, and electromechanical subsystems. As shown in FIG. 1, such systems may include a navigation system 42, an entertainment system 44, a vehicle security system 45, an audio system 46, a safety system 47, a communications system 48 preferably with a wireless transceiver, a driver assistance system 49, a passenger comfort system 50, and an engine/transmission, chassis electronics system(s) 51. Of course, other examples of vehicle control sub-systems are contemplated. In addition, it is to be understood that there may be overlap between some of these different vehicle systems and the presence or absence of these vehicle systems as well as other vehicle systems may depend upon the type of vehicle, the type of fuel or propulsion system, the size of the vehicle, and other factors and variables. In the automotive context, examples of the driver assistance system 49 may include one or more subsystems such as a lane assist system, a speed assist system, a blind spot detection system, a park assist system, and an adaptive cruise control system. In the automotive context, examples of the passenger comfort system 50 may include one or more subsystems such as automatic climate control, electronic seat adjustment, automatic wipers, automatic headlamps, and automatic cooling. In the automotive context, examples of the safety system 47 may include active safety systems such as air bags, hill descent control, and an emergency brake assist system. Aspects of the navigation system 42, the entertainment system 44, the audio system 46, and the communications system 48 may be combined into an infotainment system.

One or more wearable devices such as a set of earpieces 10 may include a left earpiece 12A and a right earpiece 12B in operative communication with the vehicle control system 40 such as through the communication system 48. For example, the communication system 48 may provide a Bluetooth or BLE or Wi-Fi link to wearable devices or may otherwise provide for communications with the wearable devices preferably through wireless communications. The vehicle 2 may communicate with the wearable device(s) directly, or alternatively, or in addition, the vehicle 2 may communicate with the wearable device(s) through an intermediary device such as a mobile device 4 which may be a mobile phone, a tablet, or other type of mobile device or other computing device.

As will be explained in further details with respect to various examples, the wearable device(s) 10 interact with the vehicle control system 40 in any number of different ways. For example, the wearable device(s) 10 may provide sensor data, identity information, stored information, streamed information, or other types of information to the vehicle. Based on this information, the vehicle may take any number of actions which may include one or more actions taken by the vehicle control system (or subsystems thereof). In addition, the vehicle 2 may communicate sensor data, identity information, stored information, streamed information or other types of information to the wearable device(s) 10.

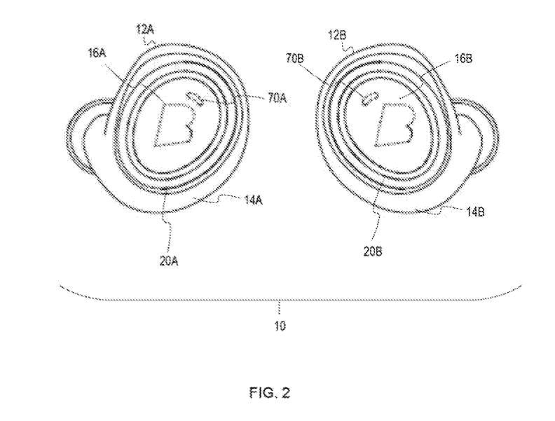

FIG. 2 illustrates one example of a wearable device in the form of a set of ear pieces 10 in greater detail. FIG. 1 illustrates a set of earpiece wearables 10 which includes a left earpiece 12A and a right earpiece 12B. Each of the earpieces wearables 12A, 12B has an earpiece wearable housing 14A, 14B which may be in the form of a protective shell or casing and may be an in-the-ear earpiece housing. A left infrared through ultraviolet spectrometer 16A and right infrared through ultraviolet spectrometer 16B is also shown. Each earpiece 12A, 12B may include one or more microphones 70A, 70B. Note that the air microphones 70A, 70B are outward facing such that the air microphones 70A, 70B may capture ambient environmental sound. It is to be understood that any number of microphones may be present including air conduction microphones, bone conduction microphones, or other audio sensors. Corona portions 20A, 20B may be present which provide lighting such as though a light pipe or guide from one or more light emitting diodes.

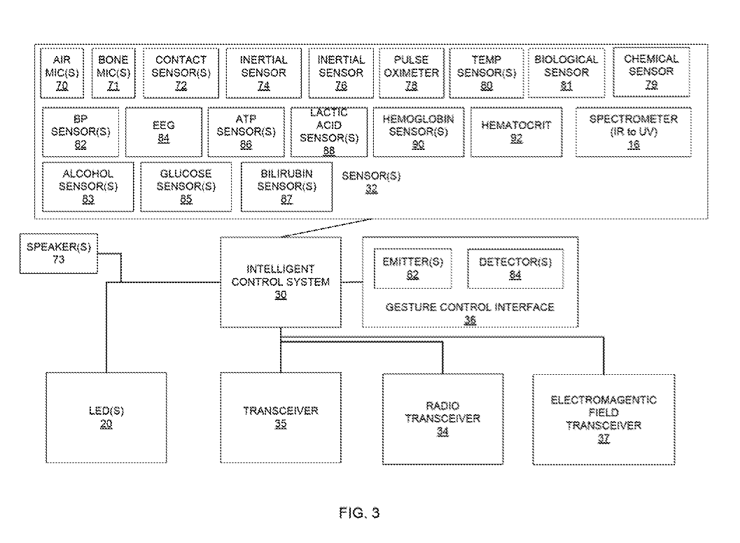

FIG. 3 is a block diagram illustrating a device. The device may include one or more LEDs 20 electrically connected to an intelligent control system 30. The intelligent control system 30 may include one or more processors, microcontrollers, application specific integrated circuits, or other types of integrated circuits. The intelligent control system 30 may also be electrically connected to one or more sensors 32. Where the device is an earpiece, the sensor(s) may include an inertial sensor 74, another inertial sensor 76. Each inertial sensor 74, 76 may include an accelerometer, a gyro sensor or gyrometer, a magnetometer or other type of inertial sensor. The sensor(s) 32 may also include one or more contact sensors 72, one or more bone conduction microphones 71, one or more air conduction microphones 70, one or more chemical sensors 79, a pulse oximeter 76, a temperature sensor 80, or other physiological or biological sensor(s). Further examples of physiological or biological sensors include an alcohol sensor 83, glucose sensor 85, or bilirubin sensor 87. Other examples of physiological or biological sensors may also be included in the device. These may include a blood pressure sensor 82, an electroencephalogram (EEG) 84, an Adenosine Triphosphate (ATP) sensor, a lactic acid sensor 88, a hemoglobin sensor 90, a hematocrit sensor 92 or other biological or chemical sensor.

A spectrometer 16 is also shown. The spectrometer 16 may be an infrared (IR) through ultraviolet (UV) spectrometer although it is contemplated that any number of wavelengths in the infrared, visible, or ultraviolet spectrums may be detected. The spectrometer 16 is preferably adapted to measure environmental wavelengths for analysis and recommendations and thus preferably is located on or at the external facing side of the device.

A gesture control interface 36 is also operatively connected to or integrated into the intelligent control system 30. The gesture control interface 36 may include one or more emitters 82 and one or more detectors 84 for sensing user gestures. The emitters may be of any number of types including infrared LEDs. The device may include a transceiver 35 which may allow for induction transmissions such as through near field magnetic induction. A short range transceiver 34 using Bluetooth, BLE, UWB, or other means of radio communication may also be present. The short range transceiver 34 may be used to communicate with the vehicle control system. In operation, the intelligent control system 30 may be configured to convey different information using one or more of the LED(s) 20 based on context or mode of operation of the device. The various sensors 32, the intelligent control system 30, and other electronic components may be located on the printed circuit board of the device. One or more speakers 73 may also be operatively connected to the intelligent control system 30.

An electromagnetic (E/M) field transceiver 37 may be operatively connected to the intelligent control system 30 to link the processor 30 to the electromagnetic field of the user. The use of the E/M transceiver 37 allows the device to link electromagnetically into a personal area network or body area network or other device.

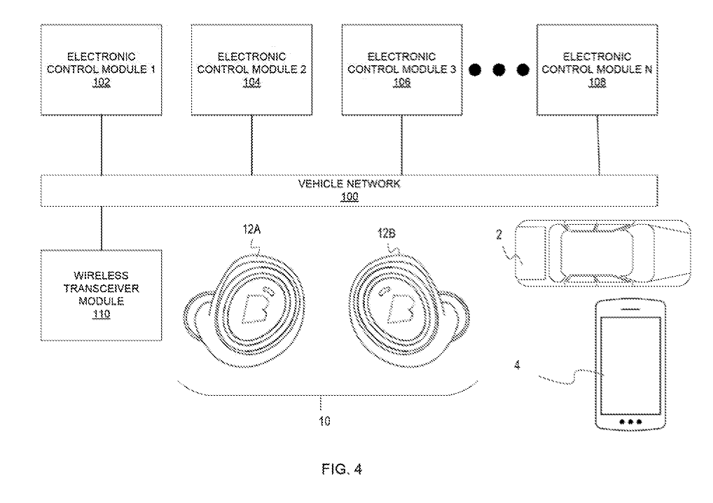

FIG. 4 illustrates another example of one or more wearable ear pieces 10 in operative communication with a vehicle. In FIG. 4, a vehicle network 100 is shown. According to one aspect, the wearable devices 12A, 12B may communicate information through a vehicle network 100 associated with a vehicle 2. Data, instructions, input, commands, files, or audio streams may be communicated over the vehicle network 100 or vehicle bus to and from the wearable devices. Protocols which are used may include a Controller Area Network (CAN), Local Interconnect Network (LIN), or others including proprietary network protocols or network protocol overlays.

Various types of electronic control modules 102, 104, 106, 108 or electronic control units may communicate over the network 100 of the vehicle. These may include electronic modules such as an engine control unit (ECU), a transmission control unit (TCU), an anti-lock braking system (ABS), a body control module (BCM), a door control unit (DCU), an electric power steering control unit (PSCU), a human-machine interface (HMI), powertrain control module (PCM), speed control unit (SCU), telematic control unit (TCU), brake control unit (BCM), battery management system, entertainment system and numerous others. Any number of electronic control modules may be operatively connected to the vehicle network 100.

In one embodiment a wireless transceiver module 110 is operatively connected to a vehicle network 100 and it is the wireless transceiver module 110 which is in operative communication with one or more wearable devices such as wearable ear pieces 12A, 12B.

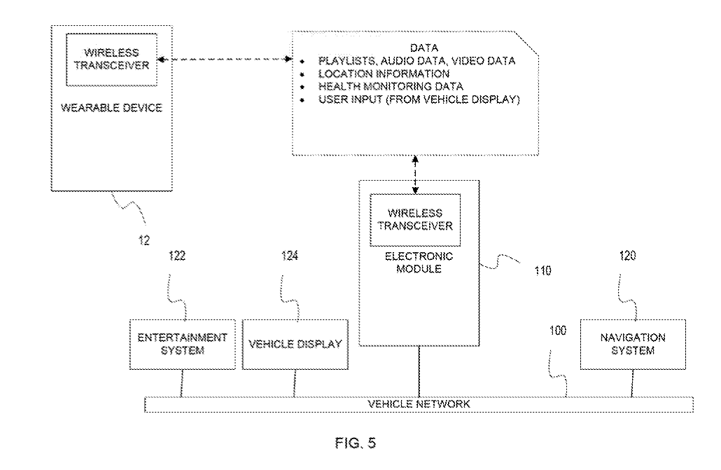

As shown in FIG. 5, one or more wearable devices 12 (including one or more ear pieces from one or more different vehicle occupants) may communicate with an entertainment system 120 of a vehicle. Although the communication may be performed directly between the navigation system 120, entertainment system 122, or vehicle display 124 and the and one or more ear pieces 12, in one embodiment a wireless transceiver module 110 may be operatively connected to the wearable ear piece 12 after the transceiver module 110 connects with or forms a wireless linkage with one or more of the ear pieces 12. The wireless transceiver module 110 may use any number of different types of communications and protocols including Bluetooth, Bluetooth Low Energy (BLE), ultra-wideband, or otherwise.

According to another aspect, there are various forms of interaction between the navigation system, entertainment system, or vehicle display of a vehicle and one or more wearable devices. One type of interaction involves the transfer of data including information about audio or video files between the one or more wearable devices and the vehicle display 124 which may be used by the entertainment system 122. It is contemplated that the entertainment system associated with the vehicle may have large amounts of storage available, larger than may be available in the wearable device(s). Thus, for example, suppose the earpieces have storage available for storing music, one or more audio files or playlists may be transferred from the vehicle to the earpiece. Alternatively, one or more audio files or playlists may be transferred from the earpiece to the vehicle. In addition, one or more audio files or playlists may be streamed from the entertainment system of the vehicle to the earpiece and one or more audio files or playlists may be streamed from the earpiece to the entertainment system of the vehicle. The vehicle display 124 may be used to display this information.

Similarly, there are various forms of interaction between the navigation system of a vehicle and one or more wearable devices. In particular, a navigation system associated with one or more wearable devices such as earpieces may integrate with the navigation system of a vehicle. According to one example one or more earpieces may provide a voice assistant for providing instructions to a user but the one or more earpieces may not have a geolocation system such as a global positioning system (GPS) receiver or GLOSNASS receiver or other geolocation system. However, the one or more earpieces may each have one or more inertial sensors which may be used to track movement of an individual. Thus, to determine geolocation or geospatial position, the one or more wearable devices may communicate with a mobile device or vehicle navigation system which includes a geolocation system. It is further contemplated that once an earpiece knows of or is calibrated to a particular geoposition, the earpiece may use information from its inertial sensors to update or track changes in its geoposition. Thus, location information may also be communicated to and from one or more earpieces. The location information, whether a starting location, destination, or intermediary location may be displayed on the vehicle display.

According to another aspect, one or more wearable devices may provide for health monitoring of an individual such as a driver or passenger of the vehicle. The wearable devices may have any number of different sensors which may be used for monitoring the health of an individual or other physical parameters of an individual. Examples of sensors may include one or more inertial sensors such as an accelerometer, a gyro sensor or gyrometer, a magnetometer or other type of inertial sensor. As shown in FIG. 3, the sensor(s) 32 may also include one or more contact sensors 72, one or more bone conduction microphones 71, one or more air conduction microphones 70, one or more chemical sensors 79, a pulse oximeter 78, a temperature sensor 80, or other physiological or biological sensor(s). Further examples of physiological or biological sensors include an alcohol sensor 83, glucose sensor 85, or bilirubin sensor 87. Other examples of physiological or biological sensors may also be included in the device. These may include a blood pressure sensor 82, an electroencephalogram (EEG) 84, an Adenosine Triphosphate (ATP) sensor, a lactic acid sensor 88, a hemoglobin sensor 90, a hematocrit sensor 92 or other biological or chemical sensor. Data associated with the health monitoring may be displayed on one or more vehicle displays 124 of the vehicle.

Various methods, system, and apparatus have been shown and described relating to vehicles with wearable integration or communication. The present invention is not to be limited to these specific examples but contemplates any number of related methods, system, and apparatus and these examples may vary based on the specific type of vehicle, the specific type of wearable device, and other considerations.

What is claimed is:

1. A system comprising:
a vehicle;
a vehicle network disposed within the vehicle;
a vehicle display operative connected to the vehicle network;
wherein the vehicle network is configured to wirelessly communicate with at least one wireless earpiece to receive data from the at least one wireless earpiece and display information associated with the at least one wireless earpiece on the vehicle display.

2. The system of claim 1 wherein the vehicle is further configured to access audio files from the at least one wireless earpiece and display information about the audio files on the vehicle display.

3. The system of claim 1 wherein the vehicle is further configured to access a playlist from the at least one wireless earpiece and display the playlist on the vehicle display.

4. The system of claim 1 wherein the vehicle is further configured to access health monitoring data from the at least one wireless earpiece and display information about the health monitoring data on the vehicle display.

5. The system of claim 1 wherein the vehicle is further configured to access a destination from the at least one wireless earpiece and display the destination on the vehicle display.

6. The system of claim 1 wherein the vehicle display is a touch screen display.

7. The system of claim 6 wherein the vehicle is configured to receive input from an occupant wearing the at least one wireless earpiece using the touch screen display and communicate the input to the at least one wireless earpiece.

8. A method for communicating information to a wireless earpiece of an occupant within a vehicle, the method comprising:
providing a vehicle having a vehicle display in operative communication with a vehicle network of the vehicle;
wirelessly connecting the vehicle to the wireless earpiece of the occupant within the vehicle; and
receiving data from the wireless earpiece and displaying the data on the vehicle display of the vehicle.

9. The method of claim 8 wherein the data is one or more audio files stored on the wireless earpiece.

10. The method of claim 8 wherein the data is a playlist stored on the wireless earpiece.

11. The method of claim 8 wherein the data is health monitoring data sensed using a sensor of the wireless earpiece.

12. The method of claim 8 wherein the data is a destination location stored on the wireless earpiece.

13. The method of claim 8 wherein the vehicle display is a touchscreen display and wherein the method further comprises receiving input from the occupant of the vehicle at the touchscreen display and sending the input to the wireless earpiece.
